(19) United States
(12) Patent Application Publication
(10) Pub. No.: US 2009/0004052 A1
(43) Pub. Date: Jan. 1, 2009

(54) Oxidation protection apparatus and method for chemical liquid

(76) Inventors: Tsuyoshi Matsumura, Kanagawa-ken (JP); Yoshihiro Uozumi, Kanagawa-ken (JP); Hiroshi Tomita, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/905,299

(22) Filed: Sep. 28, 2007

(30) Foreign Application Priority Data
Sep. 29, 2006 (JP) 2006-269288

(51) Int. Cl. B01J 19/00; B08B 13/00

(52) U.S. Cl. 422/41; 134/115 R

(57) ABSTRACT

An oxidation protection method for chemical liquid includes: supplying inert gas into a circulating bath containing the chemical liquid to make pressure inside the circulating bath higher than pressure outside the circulating bath; supplying the chemical liquid from the circulating bath to a chamber receiving a wafer; supplying inert gas into the chamber to make pressure inside the chamber higher than pressure outside the chamber; and returning the chemical liquid after washing from the chamber to the circulating bath. An oxidation protection method for chemical liquid includes: removing dissolved oxygen in the chemical liquid; supplying the chemical liquid to a chamber receiving a wafer; and returning the chemical liquid after washing from the chamber to a circulating bath.

### CROSS-REFERENCE TO RELATED APPLICATIONS

This application is based upon and claims the benefit of priority from the prior Japanese Patent Application No. 2006-269288, filed on Sep. 29, 2006; the entire contents of which are incorporated herein by reference.

### BACKGROUND OF THE INVENTION

1. Field of the Invention

This invention relates to an oxidation protection apparatus and method for chemical liquid.

2. Background Art

When a semiconductor substrate is subjected to washing and other chemical treatments using a treatment liquid, it is important to remove impurities attached to the semiconductor substrate surface and, additionally, to prevent reattachment of impurities.

As a means for preventing metal oxides from attaching on the semiconductor substrate surface, JP-A 7-221066 (Kokai) proposes a method and apparatus for preventing impurities from being mixed into a polymer remover liquid by forming a nitrogen gas curtain at the opening of a wet treatment bath.

However, the circulating system for the polymer remover liquid disclosed in JP-A 7-221066 (Kokai) is an open system, and hence there is a problem of easy intrusion of air. In view of the recent tendency of metal interconnection toward finer pitch, the problem of metal corrosion has become more serious. Therefore, in preparation for finer pitch in metal interconnection, there is a demand for a more effective oxidation protection apparatus and method for chemical liquid.

### SUMMARY OF THE INVENTION

According to an aspect of the invention, there is provided an oxidation protection method for chemical liquid, including: supplying inert gas into a circulating bath containing the chemical liquid to make pressure inside the circulating bath higher than pressure outside the circulating bath; supplying the chemical liquid from the circulating bath to a chamber receiving a wafer; supplying inert gas into the chamber to make pressure inside the chamber higher than pressure outside the chamber; and returning the chemical liquid after washing from the chamber to the circulating bath.

According to another aspect of the invention, there is provided an oxidation protection method for chemical liquid, including: removing dissolved oxygen in the chemical liquid; supplying the chemical liquid to a chamber receiving a wafer; and returning the chemical liquid after washing from the chamber to a circulating bath.

According to another aspect of the invention, there is provided an oxidation protection apparatus for chemical liquid including: a circulating bath configured to contain the chemical liquid; a chamber configured to receive a wafer and to supply the wafer with the chemical liquid to wash the wafer; an oxygen dissolve prevention device configured to prevent oxygen from dissolving in the chemical liquid.

### BRIEF DESCRIPTION OF THE DRAWINGS

FIG. 1 is a schematic view illustrating an oxidation protection apparatus for chemical liquid according to a first embodiment of the invention;

FIG. 2 is a schematic view illustrating an oxidation protection apparatus for chemical liquid according to a second embodiment of the invention;

FIG. 3 is a schematic view illustrating a modification of oxidation protection apparatus for chemical liquid according to the first and second embodiments of the invention; and

FIG. 4 is a schematic view illustrating a construction of a reservoir.

### DETAILED DESCRIPTION OF THE INVENTION

The invention will now be described with reference to embodiments. However, the invention is not limited to the following embodiments. In the drawings, elements having like or similar functions are marked with like or similar reference numerals, and the description thereof is omitted.

### First Embodiment

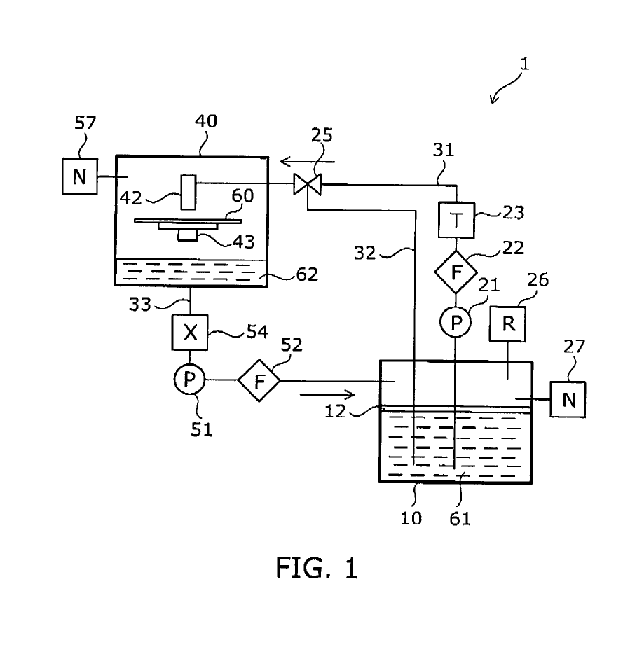

An oxidation protection apparatus for chemical liquid 1 used in the first embodiment shown in FIG. 1 comprises a circulating bath 10 containing a chemical liquid 61; a first inert gas supply means 27 for supplying inert gas into the circulating bath 10 to make the pressure inside the circulating bath 10 higher than the pressure outside the circulating bath 10; a chamber 40 for receiving a wafer 60 and supplying the wafer 60 with the chemical liquid 61 to wash the wafer 60; and a second inert gas supply means 57 for supplying inert gas into the chamber 40 to make the pressure inside the chamber 40 higher than the pressure outside the chamber 40. The circulating bath 10 includes a float 12 for covering the upper surface of the chemical liquid 61 and a reservoir 26 for exhausting the gas inside the circulating bath 10. The chamber 40 includes a nozzle 42 and a wafer holder 43. The oxidation protection apparatus for chemical liquid 1 further comprises a supply piping 31 with one end being inserted into the chemical liquid 61 in the circulating bath 10 and the other end being connected to the chamber 40, the supply piping 31 having a pump 21, a filter 22, a temperature regulator 23, and a switching valve 25 sequentially from the circulating bath 10 toward the chamber 40; a piping 32 with one end being connected to the switching valve 25 of the supply piping 31 and the other end being inserted into the chemical liquid 61 in the circulating bath 10; and a recovery piping 33 with one end being connected to the chamber 40 and the other end being connected to the circulating bath 10, the recovery piping 33 having a recovery tank 54, a pump 51, and a filter 52 sequentially from the chamber 40 toward the circulating bath 10.

The chemical liquid 61 in the circulating bath 10 sucked by the pump 21 is supplied into the treatment space inside the chamber 40 through the supply piping 31 and the nozzle 42. When the chamber 40 is not in use, the switching valve 25 is switched so that the chemical liquid 61 is returned to the circulating bath 10 without being supplied into the chamber 40. The chemical liquid 62 used for treatment in the chamber 40 is stored in the recovery tank 54. The chemical liquid 62 is then sucked up by the pump 51 and returned to the circulating bath 10 through the recovery piping 33.

The polymer remover liquid used as the chemical liquid 61 can be selected from various chemical liquids without particular limitation. For example, fluorine compounds and additives such as anticorrosive and chelating agents can be used. Specifically, a fluorine compound-containing polymer remover liquid can be used. Examples of fluorine compounds include ammonium fluoride, acidic ammonium fluoride/hydrofluoric acid, methylamine hydrofluorate, dimethylamine hydrofluorate, trimethylamine hydrofluorate, ethylamine hydrofluorate, diethylamine hydrofluorate, triethylamine hydrofluorate, ethanolamine hydrofluorate, diethanolamine hydrofluorate, triethanolamine hydrofluorate, isopropanolamine hydrofluorate, diisopropanolamine hydrofluorate, triisopropanolamine hydrofluorate, diazabicycloundecene hydrofluorate, and diazabicyclononene hydrofluorate. Preferably, the fluorine compound is ammonium fluoride, acidic ammonium fluoride/hydrofluoric acid, or buffered hydrofluoric acid. The concentration of the fluorine compound is not particularly specified, but preferably, the concentration of the fluorine compound is 0.001 to 55% by weight. Concentration lower than this range results in decreasing the possibility of corrosion. Solvent can be further contained without any problems.

Specific examples of solvents include ethylene glycol monoethyl ether, ethylene glycol monobutyl ether, diethylene glycol monomethyl ether, diethylene glycol monoethyl ether, diethylene glycol monobutyl ether, triethylene glycol, triethylene glycol monomethyl ether, triethylene glycol monoethyl ether, triethylene glycol monopropyl ether, triethylene glycol monobutyl ether, triethylene glycol dimethyl ether, propylene glycol monomethyl ether, propylene glycol monoethyl ether, propylene glycol monobutyl ether, dipropylene glycol monomethyl ether, dipropylene glycol monoethyl ether, dipropylene glycol monobutyl ether, diethylene glycol dimethyl ether, dipropylene glycol dimethyl ether, formamide, monomethyl formamide, dimethyl formamide, monoethyl formamide, diethyl formamide, acetamide, monomethyl acetamide, dimethyl acetamide, monoethyl acetamide, diethyl acetamide, N-methylpyrrolidone, N-ethylpyrrolidone, N-methylcaprolactam, methyl alcohol, ethyl alcohol, isopropanol, ethylene glycol, propylene glycol, dimethyl sulfoxide, dimethyl sulfone, diethyl sulfone, 1,3-dimethyl-2-imidazolidinone, 1-3-diethyl-2-imidazolidinone, 1-3-diisopropyl-2-imidazolidinone, γ-butylolactone, δ-valerolactone, aminoethanol, diethanolamine, triethanolamine, isopropanolamine, 1-amino-3-propanol, diisopropanolamine, triisopropanolamine, dimethylaminoethanol, N-methylaminoethanol, diethylaminoethanol, aminoethoxyethanol, ethylenediamine, diethylenetriamine, triethylenetetramine, and tetraethylenepentamine. These can be used singly or as a mixture.

Anticorrosive agents for copper may include azoles such as benzotriazole, alkyne compounds such as acetylene alcohol, and low-valent sulfur compounds such as thiourea and mercaptothiazole. Furthermore, chelating agents can be used.

The substrate material serving as a wafer 60 is not particularly limited, but can contain copper or copper alloys. Other applicable substrate materials include semiconductor interconnect materials such as silicon, amorphous silicon, polysilicon, silicon oxide film, silicon nitride film, aluminum, aluminum alloys, gold, platinum, silver, titanium, titanium-tungsten, titanium nitride, tungsten, tantalum, tantalum compounds, chromium, chromium oxides, chromium alloys, and ITO (indium tin oxide); compound semiconductors such as gallium arsenide, gallium phosphide, and indium phosphide; dielectric materials such as strontium bismuth tantalum; and LCD glass substrates.

Inert gas includes nitrogen gas and noble gas. Nitrogen gas is preferably used from the viewpoint of industrial availability and cost.

The combination of the chemical liquid and the inert gas is not particularly limited. During dry etching, nitrogen gas is preferably used. This is because, even if the metal surface at the via bottom is exposed after dry etching, nitrogen gas can prevent oxidation of the metal surface.

The circulating bath 10 is not particularly limited, but preferably has good hermeticity. This is because the pressure inside the circulating bath 10 can be kept constant when inert gas is supplied, and because impurity contamination can be prevented.

The first inert gas supply means 27 is not particularly limited, but any of various supply means can be used as long as it can supply inert gas into the circulating bath 10 and make the pressure inside the circulating bath 10 higher than the pressure outside the circulating bath 10. The same applies to the second inert gas supply means 57.

By supplying inert gas to both the circulating bath 10 and chamber 40 being hermetically sealed, dissolution of oxygen into the chemical liquid can be effectively prevented as described later.

The chamber 40 is not particularly limited, but preferably has good hermeticity. This is because the pressure inside the chamber 40 can be kept constant when inert gas is supplied, and because impurity contamination can be prevented.

The filters 22, 52 and the temperature regulator 23 are not particularly limited, but can be variously implemented. Specifically, the filters 22, 52 can be Teflon®-based circulating filters. The temperature regulator 23 can be based on an electronic cooler and a near-infrared radiation heater.

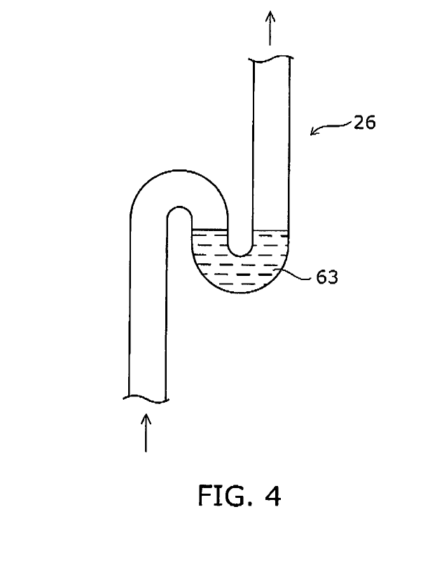

The circulating bath 10 is preferably provided with a reservoir 26. For example, as shown in FIG. 4, it is possible to provide a reservoir 26 that has a piping including a curved portion for storing a liquid 63. Then, even in the case of pressure change in the circulating bath 10, the liquid 63 inside the reservoir 26 moves up and down, and thereby the pressure inside the circulating bath 10 can be kept constant.

Next, an oxidation protection method for chemical liquid according to the first embodiment is described with reference to an example in which the oxidation protection apparatus for chemical liquid 1 is used.

(a) Inert gas is supplied to the circulating bath 10 containing a chemical liquid 61 to make the pressure inside the circulating bath 10 higher than the pressure outside the circulating bath 10. This is because dissolution of oxygen into the chemical liquid 61 can be effectively prevented by filling in the circulating bath 10 with an inert gas atmosphere. The pressure is not particularly limited as long as the pressure inside the circulating bath 10 is higher than the pressure outside the circulating bath 10. Too high pressure is not preferable from the viewpoint of workability and cost. More preferably, the gas inside the circulating bath 10 is exhausted through the reservoir 26 for preventing contact with ambient air so that the atmosphere inside the circulating bath 10 remains an inert gas atmosphere.

(b) The chemical liquid in the circulating bath 10 is sucked by the pump 21 installed on the supply piping 31, and the chemical liquid 61 is supplied to the chamber 40 through the filter 22. Preferably, immediately before the chemical liquid 61 is supplied to the chamber 40, the temperature regulator 23 installed near the chamber 40 is used to regulate the temperature of the chemical liquid 61 for keeping the temperature of the chemical liquid 61 constant, and thereby removability is stabilized.

In the standby state where the chemical liquid 61 is not supplied to the chamber 40, the chemical liquid 61 is returned to the circulating bath 10 through the piping 32 by switching connection using the switching valve 25.

(c) Inert gas is supplied into the chamber 40 to make the pressure inside the chamber 40 higher than the pressure outside the chamber 40. This is because dissolution of oxygen into the chemical liquid 61 can be effectively prevented as in step (a). The timing when inert gas is supplied into the chamber 40 is not particularly limited, but the time of loading/unloading a wafer 60 is preferable. Alternatively, inert gas may be kept supplied into the chamber 40.

(d) The chemical liquid after washing is returned from the chamber 40 to the circulating bath 10. The recovered chemical liquid is recirculated through steps (a) to (c).

According to the first embodiment, the circulating bath 10 and the chamber 40 are hermetically sealed, and inert gas is introduced therein. Thus impurity contamination can be prevented, and oxidation of chemical liquid can be effectively prevented.

### Second Embodiment

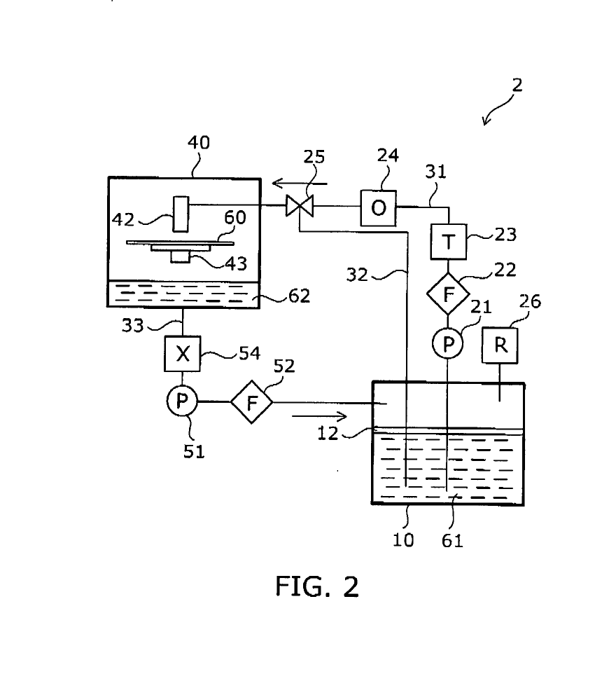

An oxidation protection apparatus for chemical liquid 2 used in the second embodiment shown in FIG. 2 comprises a circulating bath 10 containing a chemical liquid 61; a dissolved oxygen removal unit 24 for removing dissolved oxygen in the chemical liquid 61; and a chamber 40 for receiving a wafer 60 and supplying the wafer 60 with the chemical liquid 61 to wash the wafer 60. The circulating bath 10 includes a float 12 for covering the upper surface of the chemical liquid 61 and a reservoir 26 for exhausting the gas inside the circulating bath 10. The chamber 40 includes a nozzle 42 and a wafer holder 43. The oxidation protection apparatus for chemical liquid 2 further comprises a supply piping 31 with one end being inserted into the chemical liquid 61 in the circulating bath 10 and the other end being connected to the chamber 40, the supply piping 31 having a pump 21, a filter 22, a temperature regulator 23, the dissolved oxygen removal unit 24, and a switching valve 25 sequentially from the circulating bath 10 toward the chamber 40; a piping 32 with one end being connected to the switching valve 25 of the supply piping 31 and the other end being inserted into the chemical liquid 61 in the circulating bath 10; and a recovery piping 33 with one end being connected to the chamber 40 and the other end being connected to the circulating bath 10, the recovery piping 33 having a recovery tank 54, a pump 51, and a filter 52 sequentially from the chamber 40 toward the circulating bath 10.

The oxidation protection apparatus for chemical liquid 2 of FIG. 2 has the same configuration as the oxidation protection apparatus for chemical liquid 1 of FIG. 1 except that the former includes the dissolved oxygen removal unit 24 and does not include the first and second inert gas supply means 27, 57. The oxidation protection apparatus for chemical liquid 2 uses the dissolved oxygen removal unit 24 to remove dissolved oxygen in the chemical liquid 61, and thereby enabling effective oxidation protection for the chemical liquid 61.

The dissolved oxygen removal unit 24 can be based on a module using a hollow-fiber gas-liquid separation membrane with acid resistance. The installation location of the dissolved oxygen removal unit 24 is not particularly limited as long as it is installed on at least one of the supply piping 31 and the recovery piping 33. The dissolved oxygen removal unit 24 is preferably installed on the supply piping 31 for effective oxidation protection for wafers, and more preferably installed on the supply piping 31 at a position close to the chamber 40.

Next, an oxidation protection method for chemical liquid according to the second embodiment is described with reference to an example in which the oxidation protection apparatus for chemical liquid 2 is used, with focus on differences from the first embodiment.

(a) The chemical liquid 61 in the circulating bath 10 is sucked by the pump 21 installed on the supply piping 31, and the chemical liquid 61 is supplied into the chamber 40 through the filter 22, the temperature regulator 23, and the dissolved oxygen removal unit 24. Here, immediately before the chemical liquid 61 is supplied to the wafer 60, the dissolved oxygen removal unit 24 is used to remove dissolved oxygen in the chemical liquid 61. This is intended for effectively preventing oxides from being formed on the surface of the wafer 60. The amount of dissolved oxygen in the chemical liquid 61 is preferably 5 ppb or less, and more preferably 500 ppt or less.

(b) The chemical liquid 62 after washing is returned from the chamber 40 to the circulating bath 10. The recovered chemical liquid is recirculated by step (a).

According to the second embodiment, the dissolved oxygen removal unit 24 enables effective oxidation protection for the chemical liquid. The circulating bath 10 and the chamber 40 are hermetically sealed, and oxygen in the chemical liquid is removed. Thus impurity contamination can be prevented, and oxidation of chemical liquid can be effectively prevented. Removal of oxygen in the chemical liquid prevents the chemical liquid from reacting with oxygen. Thus material property change of chemical liquid and decrease of removability can be prevented.

### Other Embodiments

The invention has been described above with reference to the embodiments. However, the description and drawings constituting part of this disclosure should not be understood as limiting this invention. Various alternative embodiments, examples, and practical applications will be apparent to those skilled in the art from this disclosure.

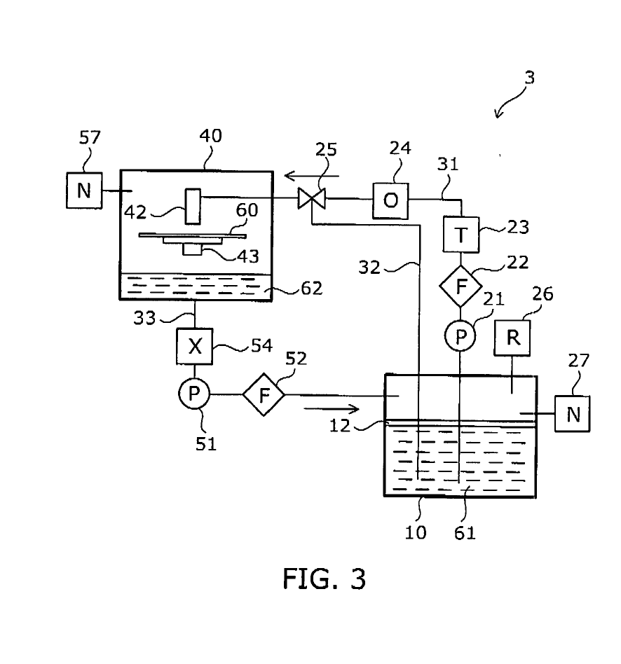

For example, oxidation of the chemical liquid 61 can be also prevented by using an oxidation protection apparatus for chemical liquid in which the apparatuses shown in FIGS. 1 and 2 are combined. An oxidation protection apparatus for chemical liquid 3 shown in FIG. 3 comprises a circulating bath 10 containing a chemical liquid 61; a first inert gas supply means 27 for supplying inert gas into the circulating bath 10 to make the pressure inside the circulating bath 10 higher than the pressure outside the circulating bath 10; a dissolved oxygen removal unit 24 for removing dissolved oxygen in the chemical liquid; a chamber 40 for receiving a wafer 60 and supplying the wafer 60 with the chemical liquid to wash the wafer 60; and a second inert gas supply means 57 for supplying inert gas into the chamber 40 to make the pressure inside the chamber 40 higher than the pressure outside the chamber 40. The circulating bath 10 includes a float 12 for covering the upper surface of the chemical liquid and a reservoir 26 for exhausting the gas inside the circulating bath 10. The chamber 40 includes a nozzle 42 and a wafer holder 43. The oxidation protection apparatus for chemical liquid 3 of FIG. 3 further comprises a supply piping 31 with one end being inserted into the chemical liquid 61 in the circulating bath 10 and the other end being connected to the chamber 40, the supply piping 31 having a pump 21, a filter 22, a temperature regulator 23, the dissolved oxygen removal unit 24, and a switching valve 25 sequentially from the circulating bath 10 toward the chamber 40; a piping 32 with one end being connected to the switching valve 25 of the supply piping 31 and the other end being inserted into the chemical liquid 61 in the circulating bath 10; and a recovery piping 33 with one end being connected to the chamber 40 and the other end being connected to the circulating bath 10, the recovery piping 33 having a recovery tank 54, a pump 51, and a filter 52 sequentially from the chamber 40 toward the circulating bath 10. The oxidation protection apparatus for chemical liquid 3 of FIG. 3 can be used to prevent oxidation of the chemical liquid 61 more effectively than the oxidation protection apparatuses for chemical liquid 1, 2 of FIGS. 1 and 2.

For the purpose of facilitating understanding of the invention, the waste valve for chemical liquid and the supply bath for new chemical liquid are not shown in the oxidation protection apparatuses for chemical liquid 1, 2, 3 of FIGS. 1 to 3, but may be suitably provided. Thus it is understood that the invention encompasses various embodiments not described herein. Therefore the scope of the invention is to be defined only by the elements recited in the accompanying claims, which are supported by the above description.

1. An oxidation protection method for chemical liquid, comprising:
supplying inert gas into a circulating bath containing the chemical liquid to make pressure inside the circulating bath higher than pressure outside the circulating bath;
supplying the chemical liquid from the circulating bath to a chamber receiving a wafer;
supplying inert gas into the chamber to make pressure inside the chamber higher than pressure outside the chamber; and
returning the chemical liquid after washing from the chamber to the circulating bath.

2. An oxidation protection method for chemical liquid, comprising:
removing dissolved oxygen in the chemical liquid;
supplying the chemical liquid to a chamber receiving a wafer; and
returning the chemical liquid after washing from the chamber to a circulating bath.

3. An oxidation protection apparatus for chemical liquid comprising:
a circulating bath configured to contain the chemical liquid;
a chamber configured to receive a wafer and to supply the wafer with the chemical liquid to wash the wafer;
an oxygen dissolve prevention device configured to prevent oxygen from dissolving in the chemical liquid.

4. The oxidation protection apparatus for chemical liquid according to claim 3, wherein the circulating bath is hermetic.

5. The oxidation protection apparatus for chemical liquid according to claim 3, wherein the chamber is hermetic.

6. The oxidation protection apparatus for chemical liquid according to claim 3, wherein the circulating bath has a reservoir.

7. The oxidation protection apparatus for chemical liquid according to claim 6, wherein the reservoir has a piping including a curved portion for storing the chemical liquid.

8. The oxidation protection apparatus for chemical liquid according to claim 3, further comprising:
a supply piping with one end being inserted into the chemical liquid in the circulating bath and other end being connected to the chamber,
a piping with one end being connected to a switching valve provided in the supply piping and other end being inserted into the chemical liquid in the circulating bath; and
a recovery piping with one end being connected to the chamber and other end being connected to the circulating bath.

9. The oxidation protection apparatus for chemical liquid according to claim 8, wherein the supply piping has a temperature regulator.

10. The oxidation protection apparatus for chemical liquid according to claim 8, wherein the chemical liquid is returned to the circulating bath through the piping when the chemical liquid is not supplied to the chamber.

11. The oxidation protection apparatus for chemical liquid according to claim 8, wherein the oxygen dissolve prevention device includes
a first inert gas supply device configured to supply inert gas into the circulating bath to make pressure inside the circulating bath higher than pressure outside the circulating bath; and
a second inert gas supply device configured to supply inert gas into the chamber to make pressure inside the chamber higher than pressure outside the chamber.

12. The oxidation protection apparatus for chemical liquid according to claim 11, wherein the inert gas includes nitrogen.

13. The oxidation protection apparatus for chemical liquid according to claim 11, wherein the inert gas is supplied into the chamber when wafer is loaded and unloaded.

14. The oxidation protection apparatus for chemical liquid according to claim 11, further including:
a dissolved oxygen removal unit configured to remove dissolved oxygen in the chemical liquid.

15. The oxidation protection apparatus for chemical liquid according to claim 3, wherein the oxygen dissolve prevention device includes a dissolved oxygen removal unit configured to remove dissolved oxygen in the chemical liquid.

16. The oxidation protection apparatus for chemical liquid according to claim 15, further comprising:
a supply piping with one end being inserted into the chemical liquid in the circulating bath and other end being connected to the chamber,
a piping with one end being connected to a switching valve provided in the supply piping and other end being inserted into the chemical liquid in the circulating bath; and
a recovery piping with one end being connected to the chamber and other end being connected to the circulating bath.

17. The oxidation protection apparatus for chemical liquid according to claim 16, wherein the dissolved oxygen removal unit is installed on the supply piping.

18. The oxidation protection apparatus for chemical liquid according to claim 16, wherein the dissolved oxygen removal unit is installed on the supply piping at a position close to the chamber.

19. The oxidation protection apparatus for chemical liquid according to claim 15, wherein a concentration of the dissolved oxygen in the chemical liquid is 5 ppb or less.

20. The oxidation protection apparatus for chemical liquid according to claim 15, wherein a concentration of the dissolved oxygen in the chemical liquid is 500 ppt or less.
